(19) United States
(12) Patent Application Publication
(10) Pub. No.: US 2008/0306507 A1
(43) Pub. Date: Dec. 11, 2008

(54) Therapeutic Facial Mask

(75) Inventor: John Vivian Woodley, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(73) Assignee: ATQOL PTY LTD, Southport (AU)

(21) Appl. No.: 10/580,820

(22) PCT Filed: Nov. 26, 2004
(86) PCT No.: PCT/AU2004/001659

§ 371 Date: Aug. 20, 2008

(30) Foreign Application Priority Data
Nov. 26, 2003 (AU) 2003906541

(51) Int. Cl. A61H 1/00

(52) U.S. Cl. 606/204; 606/204.15

(57) ABSTRACT

A therapeutic beauty mask comprising a mask body (1), means (2) for attaching and securing the body to cover at least a portion of a person's face, and a plurality of pressure points (3) extending from an undersurface of the mask body (1), said pressure points (3) being adapted or adjustable to coincide with known acupressure points of the human face.

### TECHNICAL FIELD

The present invention relates to facial masks and in particular, masks used to improve the health and wellbeing of humans.

### BACKGROUND ART

Chinese acupressure has been used for centuries due to its efficacious self-curative abilities of the body in a holistic way via treatment of a local symptom in an attempt to relieve a systemic body dysfunction.

Acupressure is the process of stimulating key points within the body with firm, steady pressure to gain access to the body's branching meridian network. The meridian system is a series of invisible channels that branch throughout the body and connect acupressure points allowing the local effects to extend throughout the whole system.

Other similar treatments are described by the following published patents:
U.S. Pat. No. 4,117,837
U.S. Pat. No. 3,971,387
U.S. Pat. No. 1,692,669
U.S. Pat. No. 2,191,080
U.S. Pat. No. 3,279,468
U.S. Pat. No. 5,527,357

As can be ascertained from a review of the prior published patents, the various forms of apparatus are in general complex and in most cases would require skilled supervision to be used safely and effectively.

An objective of the present invention is to provide a therapeutic treatment mask which provides beneficial treatment at an economical cost.

Further objects and advantages of the present invention will become apparent from the ensuing description which is given by way of example only.

### DISCLOSURE OF INVENTION

According to the present invention, there is provided a therapeutic treatment mask comprising

(a) a mask body,

(b) means for attaching and securing the body to cover at least a portion of a person's face,

(c) a plurality of pressure points extending from an undersurface of the mask body, said pressure points being adapted or adjustable to coincide with acupressure points of the human face.

Preferably, the mask will be designed to cover the eye and nose region of the person's face.

The mask body can be rigid or flexible. The mask will generally be manufactured from a flexible and resilient material such as a plastics material to allow it to adapt to the facial contours of different users. The mask body will preferably be provided with a plurality of groups of apertures, each group located in the mask at a location corresponding to local acupressure areas of the face, such that when in position, the groups of apertures in the mask overlie the local acupressure areas of the face. Suitably, the mask can also allow the skin of a person's face to “breathe”.

Each of the groups of apertures may be provided with multiple apertures laid out in a pattern. The pattern may be specifically adapted to allow attachment of the pressure points.

The mask body can be moulded or fabricated.

The body typically has apertures for a person's eyes and is designed to fit over or around a person's nose.

The pressure points will generally be removably attachable to the mask in order that their specific positions can be adjusted to suit a user.

The pressure points may comprise a plurality of metal or plastic knobs or balls. The knobs or balls may typically have a hemispherical or curved outer surface. The pressure points knobs may be provided with a variety of degrees of curvature to increase or decrease the amount of pressure applied to a person's face.

The pressure point knobs may be manufactured from a plastic material and will generally be substantially rigid. The knobs will typically include a mounting portion extending from the rear of the hemispherical or curved outer surface to facilitate mounting of the knobs on the mask.

The knobs may be in clusters coinciding with selected positions on the forehead and cheek bones of the human face. The knobs my be provided in a variety of configurations such as a single knob, two knobs adjacent one another, or multiple knobs ion clusters. Each knob will typically have a mounting portion.

The mask focuses on the principles of acupressure, by stimulating 3 major acupressure areas within the face through its specific placement of acupressure point stimulators.

The use of the mask acts on specific local acupressure areas of the face to improve facial appearance.

By activating these local points, the effect is encouraged throughout the total body via the meridian system to improve total skin conditioning.

The application of the mask works via specifically placed adjustable therapeutic knobs attached to the mask that act to relax any local muscle spasm in the facial region.

By relieving muscle tension, the facial muscles are able to relax and elongate to their full length.

This process enhances blood flow to the region, which promotes improved circulation and assists in the removal and build-up on any toxic substances in the area.

Additionally, by increasing the circulation in the area, the delivery of oxygen and nutrients to the facial tissue is improved to enhance overall health and improve the tone, texture and appearance of a user's face.

The major benefits of the mask are experienced in relieving acne and facial blemishes.

Often severe acne is accentuated by stress and increased tension.

The mask assists to reduce acne by relaxing the muscle tissue and improving facial tone.

The accompanying increase in blood flow assists to clear toxic residue that may promote the re-occurrence of acne and promote overall health of the skin. The mask typically achieves these effects via its specific activation of 3 acupressure points:
1) ST2/4-white point: This point is located 1 finger width below the eye socket and directly below the coloured part of the eye. Activation of this point has a major role in the above process of relieving acne and refining skin blemishes.
2) ST3/Facial Beauty: This point sits directly below the ST2 point at the base of the cheekbone. In addition to relieving acne and improving the appearance of blemishes, this point assists to eliminate sagging and improving skin tone to give the skin a more youthful and healthy glow.
3) GV4.5/3^{rd} Eye Point: This point sits directly between the eyes and has a major role in acne control via its activation and link to the hormone secreting pituitary gland and assists to enhance total skin condition.

The therapeutic knobs may be crafted from stainless steel.

The mask may be held in place with an elastic strap that is adjustable to ensure the correct pressure is applied at all times, which enhances the benefits offered by the therapeutic face mask. Other straps may be use in the alternative for example straps with Velcro® securing means may be used to allow a simple and quick adjustment for different users.

### BRIEF DESCRIPTION OF THE DRAWINGS

Aspects of the present invention will now be described with reference to the accompanying drawings in which:

FIG. 1 is a front view of a treatment mask of the present invention, and

FIGS. 2 and 2a are plan and side views of knobs for the mask of FIG. 1.

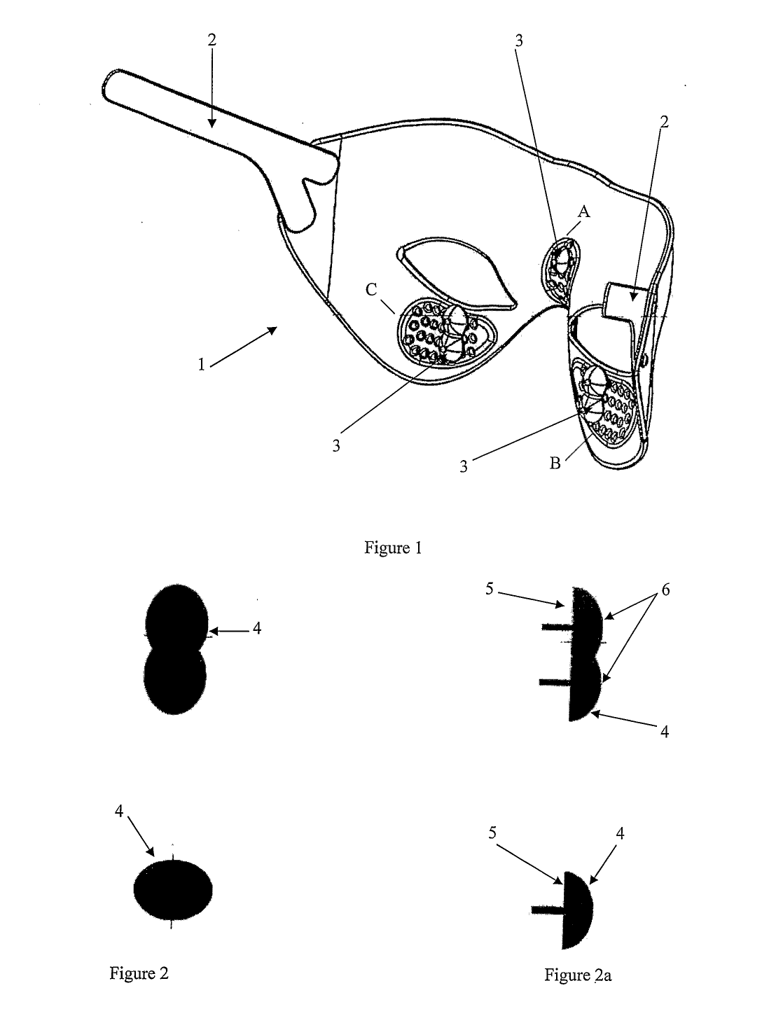

The mask of the present invention comprises a mask body generally indicated by arrow 1 and means such as adjustable elastic straps 2 for securing the body so that it covers the eye and nose region of a user's face.

A plurality of pressure points 3 are secured to the underside of the mask body.

The pressure points 3 are provided by metal knobs which are substantially oval-shaped in plan and having a curved top surface 4 and a flat undersurface 5.

The knobs 3 may be formed in sterling silver, stainless steel or the like.

The knobs 3 can be secured to the underside of the mask body at sites A, B and C which coincide with specific acupressure points discussed previously.

The knobs may be in a cluster at sites A and B or spaced as illustrated at site C.

The knobs 3 may be fixed to the underside of the mask by Velcro® strips or by other means with their curved top surfaces outermost.

The mask body may be moulded or fabricated in a semi-rigid material.

Each knob 3 may have a nipple 6 to accentuate pressure at the point they are applied to the face.
To prepare the mask, a user first adjusts the elastic or Velcro® strap to ensure the correct pressure is applied to the acupressure point. The pressure should be firm, yet comfortable pressure.
The mask is beneficially applied for 1-5 minutes, but typically about 2 minutes per day. It is important that the mask be applied on a daily basis. The mask can be applied at night prior to sleep, which ensures that your mask becomes a part of a daily routine and encourages total deep relaxation.
As the user's face becomes accustomed to the pressure, it can be increased by using the elastic or Velcro® strap.

1. A therapeutic beauty mask comprising
(a) a mask body,
(b) means for attaching and securing the body to cover at least a portion of a person's face,
(c) a plurality of passive pressure points extending from an undersurface of the mask body, said pressure points being adapted or adjustable to coincide with known acupressure points of the human face.

2. The mask as claimed in claim 1 wherein the mask covers eye and nose regions of the person's face.

3. The mask as claimed in claim 1 wherein the mask body is moulded.

4. The mask according to claim 1 wherein the pressure points include a hemispherical or curved outer surface to contact the face when the mask is in position.

5. The mask as claimed in claim 4 wherein the mask body is provided with a plurality of groups of apertures, each group located in the mask at a location corresponding to local acupressure areas of the face, such that when in position, the groups of apertures in the mask overlie local acupressure areas of the face.

6. The mask as claimed in claim 5 wherein the pressure points include a mounting portion extending from the rear of the hemispherical or curved outer surface to facilitate mounting of the knobs on the mask.

7. The mask as claimed in claim 1 wherein the body is moulded in a resilient material.

8. The mask according to claim 1 wherein the pressure points are removably attachable to the mask.

9. The mask as claimed in claim 1 wherein the body is moulded with eye apertures and has a shaped nose portion.

10. The mask as claimed in claim 1 wherein the pressure points are in clusters coinciding with selected positions on the forehead and cheek bones of the human face.
